(19) United States
(12) Patent Application Publication
(10) Pub. No.: US 2004/0193291 A1
(43) Pub. Date: Sep. 30, 2004

(54) Production management method using delivery date prediction

(75) Inventor: Akiko Sakai, Hyogo (JP)

Correspondence Address: MCDERMOTT, WILL & EMERY, 600 13th Street, N.W., Washington, DC, 20005-3096, US

(73) Assignee: RENESAS TECHNOLOGY CORP.

(21) Appl. No.: 10/667,672

(22) Filed: Sep. 23, 2003

(30) Foreign Application Priority Data
Mar. 25, 2003 (JP) 2003-082925(P)

(51) Int. Cl. G05B 13/02

(52) U.S. Cl. 700/28; 700/96

(57) ABSTRACT

A production management method includes the steps of: pre-storing production information including delivery date information, manufacturing apparatus information and lot information; calculating a scheduled shipping date for each lot on the basis of the production information; reading a delivery date of the lot; calculating the number of delay days of the lot; outputting an alarm to the lot when the number of delay days is a positive number; and analyzing the main cause of the delay of the lot and generating an expedite instruction when the number of delay days is larger than 1.

### BACKGROUND OF THE INVENTION

1. Field of the Invention

The present invention relates to a technique of producing products such as semiconductor memories and, more particularly, to a production management method for efficiently executing production management while shortening a delivery date.

2. Description of the Background Art

In recent years, a system for linking a computer and production facilities and controlling production from production planning to production process by the computer in a unified manner is developed. Such a system is also applied to, for example, a process for producing integrated circuits such as semiconductor memories. The process herein denotes a CVD (Chemical Vapor Deposition) process of depositing an insulation film on a wafer on which integrated circuits are formed, a diffusion process for introducing impurities into the surface of a semiconductor, and the like.

Japanese Patent Laying-Open No. 2002-341920 discloses a production management method for a semiconductor device, for managing production of products via a production line on which products having different degrees of importance of maintaining shipping schedules mixedly exist, including the steps of: dividing a whole manufacture process into a plurality of process groups; and controlling delivery on the process group unit basis, wherein the higher the degree of importance of maintaining shipping schedule of a product is, the number of process groups divided is increased.

According to the production management method, by controlling assignment of priorities to a group of lots which are being processed by a producing apparatus the order of lots so that a higher priority is given to a lot having a higher degree of delay than to a lot having a lower degree of delay, the method can make up for the delay of the whole group of lots.

Japanese Patent Laying-Open No. 2002-99318 discloses a process management method for a manufacture line for manufacturing finished products through a plurality of process steps including a process condition determining step and a process condition examining step, including: a manufacture flow generating step of generating a manufacture flow and registering the manufacture flow onto a database; a product progress information collecting step of collecting progress information of products and registering the progress information onto the database; and a scheduling step of calculating the degree of progress or delay at a certain time point of a product and a completion schedule date from scheduled process time of each step or actual process time. In the manufacture flow generating process, a process unit based on the process condition determining step or process condition examining step is set on the step unit basis. In the scheduling process, the degree of progress or delay is calculated on the process unit basis.

According to the process management method, in a line for manufacturing a product of which process conditions are examined such as a development/trial line, persons in charge of processes in steps and progresses of lots of the persons in charge can be always clearly grasped and a countermeasure against the main cause of a delay in the progress of any lot can be promptly taken. The method easily makes the persons in charge conscious about increase in progress speed. Thus, delivery maintaining ratio can be improved.

Japanese Patent Laying-Open No. 11-188583 discloses a lot lead-time display device for managing lead time of each of shops constructing a manufacture line. The lot lead-time display device includes: an input unit for inputting data; a production planning data input processing section for processing production planning data inputted from the input unit; a production planning data storage section for storing the production planning data which has been inputted and processed; a necessary lead-time data processing section for setting necessary lead-time for each lot inputted from the input unit; a necessary lead-time data storage section for storing necessary lead-time data; a managing unit for scheduling lead-time of each a lot from the stored production planning data and the necessary lead-time data on a shop unit basis; an actual lead-time processing section for processing actual lead-time of each lot, which is inputted from the input unit; and a display section for comparing the lead time of each lot scheduled on the shop unit basis with the actual lead time and displaying the presence or absence of a delay in the schedule.

Since the lot lead-time display device performs the production planning and scheduling of shops on the basis of necessary lead-time data, determines the presence or absence of a delay from the scheduled lead-time and actual lead-time based on start and completion data in actual shops, and displays the presence or absence of a delay. Thus, the lead-time information on the shop unit basis can be made obvious.

Japanese Patent Laying-Open No. 9-277141 discloses a process scheduling method for drawing up a schedule by assigning processes on each lot to resources at the time of simultaneously processing a plurality of lots requiring a plurality of processes using a plurality of resources, including the steps of: setting ideal termination time of each process for each lot; generating a temporary time table of the earliest time when a necessary resource of a process to be scheduled of a lot can be assured; setting a first reference value and a second reference value larger than the first reference value; obtaining a difference value obtained by subtracting termination time of the process to be scheduled derived from the time table of the process to be scheduled from the ideal termination time of the process; determining a progress state of each process to be scheduled from a first progress state in which the difference value is smaller than the first reference value, a second progress state in which the difference value is larger than the first reference value and smaller than the second reference value, and a third progress state in which the difference value is larger than the second reference value; selecting a process of the smallest difference value when a progress in the first progress state exists, selecting a process of the smallest difference value when a process in the first progress state does not exist and a process in the second progress state exists in processes of which process start time is the earliest, selecting a process of which termination time is the earliest when a process in the first progress state does not exist and only a process in the third progress state exists in processes of which process start time is the earliest; drawing up a schedule of the selected process; setting the lot as a process to be scheduled of the next process; and repeating the process.

According to the process scheduling method, by using the first reference value (delay determination value), a lot which seems to become behind the schedule is regarded as a delayed lot and a priority is given to the lot. A schedule is drawn up so that a lot which seems to become behind the schedule a little later is set as a lot requiring attention and is processed with shortest waiting time, thereby enabling the schedule to be maintained.

Japanese Patent Laying-Open No. 6-203042 discloses a production line plan generating method of generating a production line plan by a scheduler, which predicts process time of each of processes in a production line for producing lots in accordance with the order of manufacture, a time schedule of manufacturing processes, and priorities preliminarily given to the lots, wherein the scheduler predicts the date of completion of each lot, calculates an allowance to a delivery of the lot from the predicted completion date and the delivery, and changes the given priority in accordance with the calculated allowance.

According to the production line plan generating method, different from conventional techniques of drawing up a schedule with priorities fixed to lots, a schedule is drawn up while checking an allowance to a delivery and changing the priority. Consequently, processes are not performed only to a specific lot.

Japanese Patent Laying-Open No. 5-131345 discloses a production progress control system for controlling priorities of works to a group of lots being subjected to a process, including the steps of calculating scheduled termination time of all of processes of each lot from a target term of work of each lot and standard work time of each process; and using delay time calculated from the difference between actual date and time and the scheduled completion date and time as a factor of determining a priority.

According to the production progress control system, by calculating scheduled date and time of termination of all of processes from the target term of work of each lot and standard work time of each process and obtaining the difference between the scheduled date and time and actual date and time, delay time can be computed. Consequently, an instruction can be given so as to preferentially work on a lot which is most behind in the group of lots in each process.

However, all of the techniques have the following problems.

The production management method disclosed in Japanese Patent Laying-Open No. 2002-341920 manages deliveries on the basis of the degree of importance of maintaining deliveries, so that deliveries cannot be managed from various viewpoints.

According to the process managing method disclosed in Japanese Patent Laying-Open No. 2002-99318, only a schedule for process management is drawn up. The method cannot deal with a case where lots are not delivered in time.

The lot lead-time display device disclosed in Japanese Patent Laying-Open No. 11-188583 displays the presence or absence of a delay in a schedule and it just makes a delay obvious.

The process scheduling method disclosed in Japanese Patent Laying-Open No. 9-277141 just draws up a schedule such that a process is performed with the shortest waiting time on the basis of the difference value obtained by subtracting termination time of each process to be scheduled derived from a time table of processes to be scheduled from ideal termination time of the process.

The production line plan generating method disclosed in Japanese Patent Laying-Open No. 6-203042 changes a given priority in accordance with an allowance to a delivery of a lot from predicted completion date and the delivery of the lot but cannot deal with the other delivery priority factors.

The production progress control system disclosed in Japanese Patent Laying-Open No. 5-131345 simply preferentially processes a lot which is most behind schedule.

As described above, the techniques disclosed in the publications cannot manage deliveries in production processes of a semiconductor device including complicated processes in which a number of lots are simultaneously processed from various viewpoints.

### SUMMARY OF THE INVENTION

An object of the present invention is to provide a production management method capable of outputting an accurate instruction on a product in a production process.

Another object of the present invention is to provide a production management method capable of accurately detecting a product in a production process, which is behind schedule.

Still another object of the present invention is to provide a production management method capable of preventing a product from being shipped later than a delivery date on the basis of the state of the product in a production process.

Yet another object of the present invention is to provide a production management method capable of preventing a product in a production process from being shipped later than a delivery date from various viewpoints.

A production management method according to the present invention manages a production process of producing products on a lot unit basis. The production management method includes the steps of: pre-storing production information including a delivery date of said lot, a process amount, a term of work, and operating states and production capabilities of a manufacturing apparatus; calculating a delivery date prediction for each of said lots on the basis of said production information and determining whether or not there is a delay in each of said lots on the basis of the delivery date prediction and the delivery date; outputting an alarm for a lot having a delay; and analyzing the cause of the delay and instructing a proper countermeasure for the cause of the delay when the degree of the delay is higher than a predetermined degree.

Since the delivery date prediction is calculated for each lot on the basis of the production information, an accurate expedite instruction can be outputted to a lot in a production process. In addition, a delivery date delay of a product in a production process can be accurately detected. Further, a delivery date delay can be made up for on the basis of states of a lot in a production process and states of a manufacturing apparatus in the production process and can be prevented.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an overall configuration diagram of a production management system according to a first embodiment of the present invention;

FIG. 2 is a table showing delivery date information in a data storage section shown in FIG. 1;

FIG. 3 is a table showing manufacturing apparatus information in the data storage section shown in FIG. 1;

FIG. 4 is a table showing lot information in the data storage section shown in FIG. 1;

FIG. 5 is a flowchart of a program executed by a processing section in a production management system according to the first embodiment of the present invention;

FIGS. 6 and 7 are tables each showing a result of execution of the processing section; and

FIG. 8 is a flowchart of a program executed by a processing section in a production management system according to a second embodiment of the present invention.

### DESCRIPTION OF THE PREFERRED EMBODIMENTS

Hereinafter, description will be given of embodiments of the present invention with reference to the drawings. In the following description, the same constituents are attached by the same symbols. The names of the constituents and functions there of are the same as each other. Therefore, none of detailed descriptions thereof will be repeated.

First Embodiment

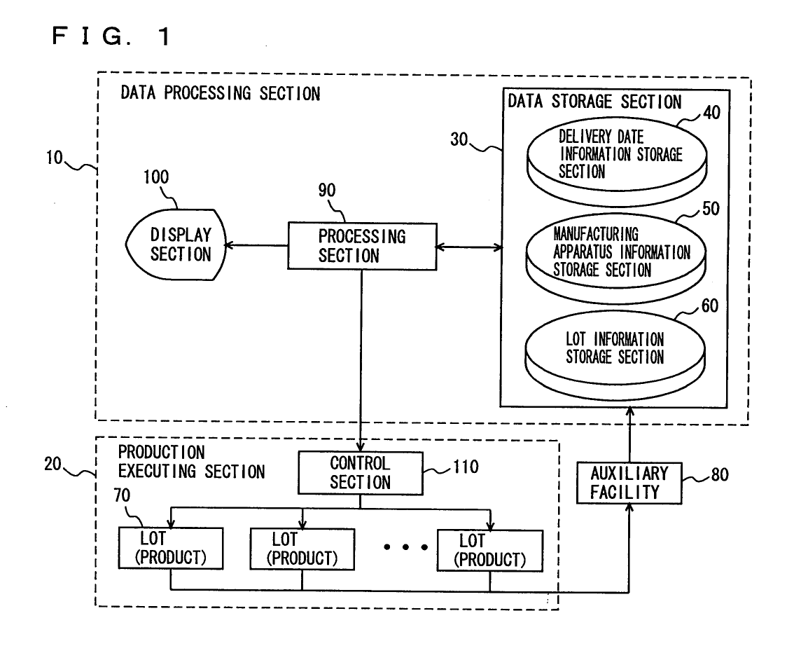

Hereinafter, description will be given of a production management system according to a first embodiment of the present invention. The production management system is constructed by a computer having a scheduling function, and the like. As shown in FIG. 1, the production management system is constructed by a data processing section 10 and a production executing section 20, and data processing section 10 includes a data storage section 30. Data storage section 30 includes a delivery date information storage section 40, a manufacturing apparatus information storage section 50, and a lot information storage section 60.

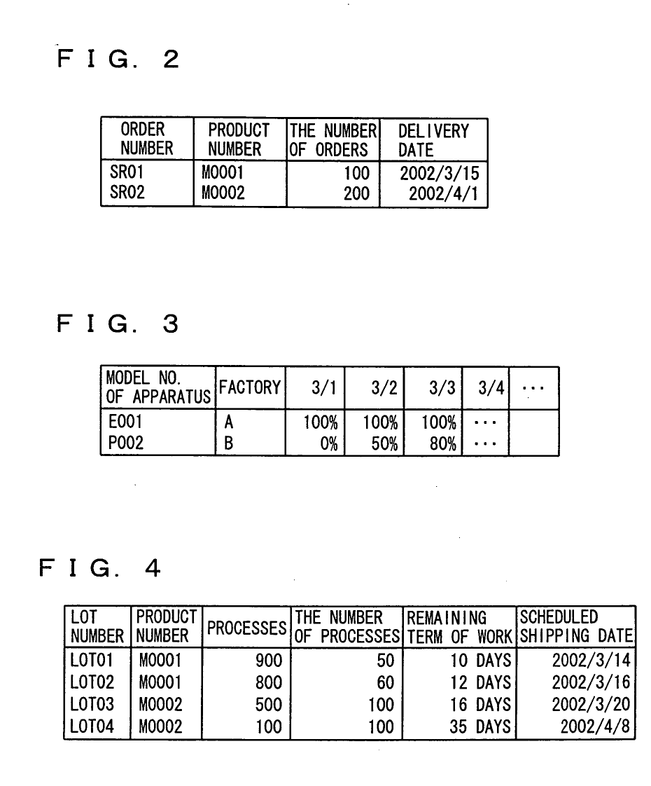

FIG. 2 shows delivery date information stored in delivery date information storage section 40. As shown in FIG. 2, as the delivery date information, order information including delivery date from a customer is pre-stored. FIG. 3 shows manufacturing apparatus information stored in manufacturing apparatus information storage section 50. As shown in FIG. 3, as the manufacturing apparatus information, operating states and capabilities of each manufacturing apparatus are pre-stored. FIG. 4 shows lot information stored in lot information storage section 60. As shown in FIG. 4, as the lot information, production record information including process and delivery of each lot which is received from each lot 70 via an auxiliary facility 80 is stored.

A processing section 90 in data processing section 10 shown in FIG. 1 is a central processing unit or a processor for performing scheduling on the basis of the information in data storage section 30. A display section 100 displays a result of scheduling executed by processing section 90 and outputs an alarm.

The production executing section 20 shown in FIG. 1 includes a control section 110 and lots 70. Control section 110 is an apparatus for executing production by transmitting a manufacture instruction to a manufacture auxiliary facility in each manufacture process on the basis of the scheduling result. Lot 70 indicates a group of lots processed on a production line and its record data is transmitted to data storage section 30 via auxiliary facility 80.

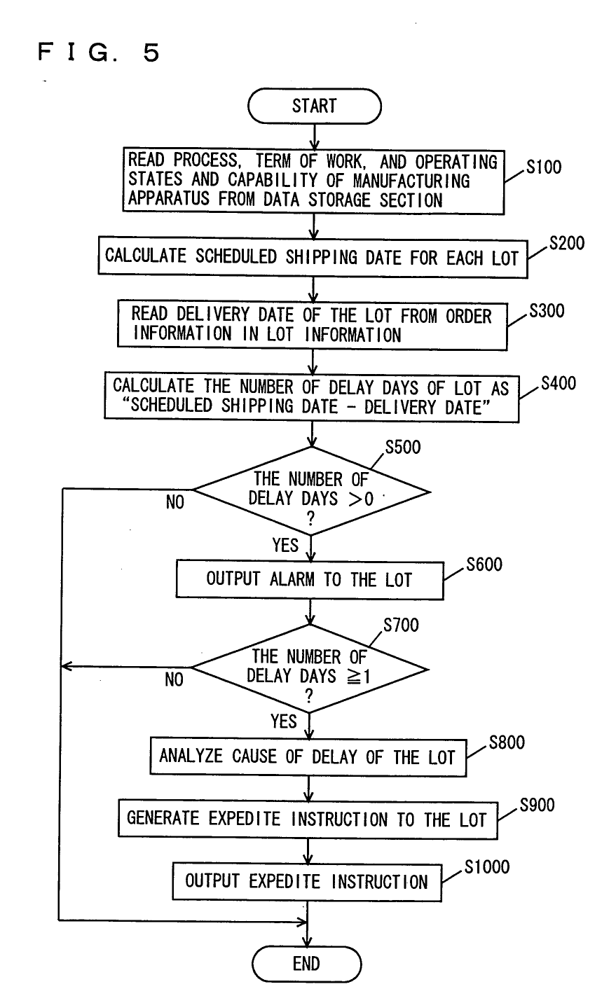

Referring to FIG. 5, description will be given of a control structure of a program executed by processing section 90 shown in FIG. 1.

In step (hereinafter, abbreviated as S) 100, processing section 90 reads out process, term of work, operating states and capabilities of a manufacturing apparatus from data storage section 30. At this time, the delivery date information stored in delivery date information storage section 40 in data storage section 30, manufacturing apparatus information stored in manufacturing apparatus information storage section 50, and lot information stored in lot information storage section 60 are read from processing section 90, respectively.

In S200, processing section 90 calculates a scheduled shipping date for each lot. Specifically, processing section 90 calculates a scheduled shipping date for each lot on the basis of the process, term of work, and operating states and capabilities of the manufacturing apparatus read in S100. In S300, processing section 90 reads out the delivery date of the lot from the order information in the lot information. In S400, processing section 90 calculates the number of delay days of the lot as “shipping date—delivery date”.

In S500, processing section 90 determines whether or not the number of delay days is larger than 0. When the number of delay days is larger than 0, the scheduled shipping date is behind the delivery date. When the number of delay days is larger than 0 (YES in S500), the process proceeds to S600. When the number of delay days is not larger than 0 (NO in S500), the process is finished.

In S600, processing section 90 outputs an alarm to the lot. Specifically, processing section 90 makes display section 100 display the alarm information to the lot.

In S700, processing section 90 determines whether or not the number of delay days is equal to or larger than 1. When the number of delay days is one or more (YES in S700), the process proceeds to S800. When the number of delay days is less than 1 (NO in S700), the process is finished.

In S800, processing section 90 analyzes the main cause of the delay of the lot. In S900, processing section 90 generates an expedite instruction to the lot. In S1000, processing section 90 outputs the expedite instruction to display section 100.

Description will be given of the operation of the production management system according to this embodiment on the basis of the structure and the flowchart.

By control section 110 of production executing section 20, a process on lot 70 is executed in each manufacturing apparatus in the production process. A production record as a record of execution is transmitted to data storage section 30 via auxiliary facility 80.

At predetermined time intervals, processing section 90 reads out the process, term of work, and operating states and capabilities of the manufacturing apparatus from data storage section 30 (S100), and calculates the scheduled shipping date for each lot on the basis of the read information (S200). The delivery date of the lot is read out from the order information in the lot information stored in lot information storage section 60 (S300) and the number of delay days of the lot is calculated as “scheduled shipping date—delivery date” (S400).

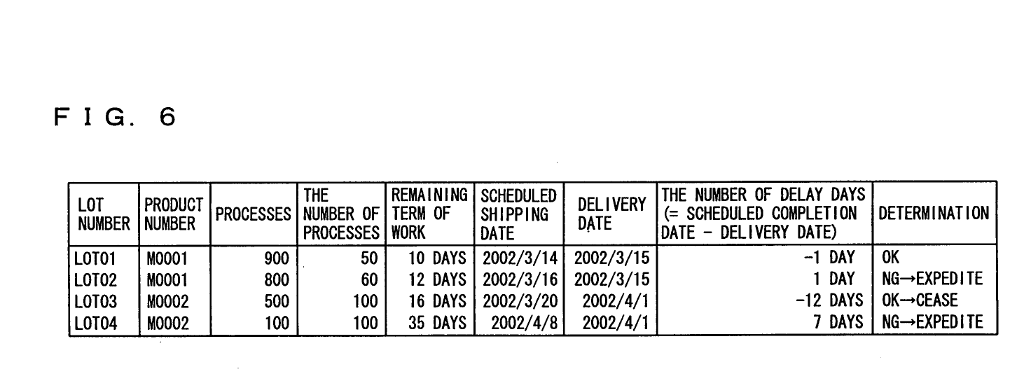

When the number of delay days is larger than 0 (YES in S500), the scheduled shipping date is behind the delivery date, that is, delay in the delivery generates, so that an alarm to the lot is outputted from display section 100 (S600). For a lot of which shipping date is behind the delivery date as shown in FIG. 6, an alarm is generated. As shown in FIG. 6, the number of delay days is one and seven for lots LOT02 and LOT04, respectively, and the lots are objects to which an alarm is generated. On the lots to which the alarm is generated, the lot expedite instruction is given. When the lots can be back on the schedules, the lot itself can be prevented from being shipped later than the delivery date. Not only the expedite instruction is outputted but also the cause of the delay is determined. By instructing a countermeasure for the cause, the lot expected to be late for the delivery can be effectively expedited without causing delay of other lots for the delivery.

For the lot of which number of delay days is one or more (YES in S700), the main cause of the delay of the lot is analyzed (S800), and the expedite instruction to the lot is generated (S900) and is outputted from the display section 100 (S1000).

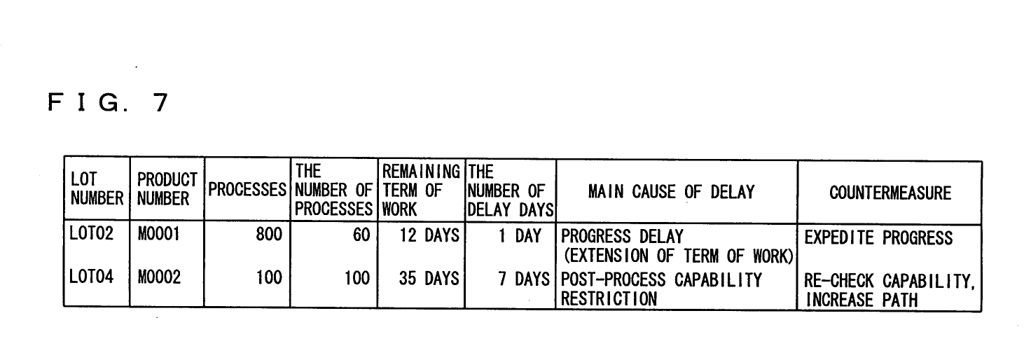

FIG. 7 specifically shows lots LOT02 and LOT04 predicted to be late for their delivery dates in FIG. 6. At present, the lots are behind the schedule and there are various reasons for the delay. In order to promptly expedite the lots, it is necessary to take a countermeasure for each cause of the delay.

With respect to lot LOT02, the term of work is advanced from the schedule, and it is determined that there is no problem with the operation states and capabilities in each manufacturing apparatus scheduled to perform a process later. In this case, it is determined that the progress of lot LOT02 is simply delayed, so that lot LOT02 can make up for the delay by expediting the work.

On the other hand, with respect to the lot LOT04, the term of work is as planned but one of apparatuses which will perform a process later cannot execute a process due to a failure (post-process capability restriction). In this case, to make up for the delay of lot LOT04, a countermeasure of increasing a path to the apparatus, executing the process by a spare processing apparatus or the like is necessary.

The case of lot LOT04 includes the case such that, even when the presently started process is not behind an ideal schedule for the delivery date, due to insufficient capabilities in a line, an apparatus, and the like which will perform a process in future, the lot will not be delivered by the delivery date. When the manufacturing process is managed on the basis of the number of delay days calculated by the difference between the date of the present process and the ideal schedule date, a lot (LOT04) of such a case is escaped. It is important to always manage a production on the basis of a delay predicted from the latest scheduled shipping date in which the process, term of work, operating states and capabilities of each manufacturing apparatus, and the like are considered and the delivery date. Specifically, a corrected delivery date prediction of lot LOT04 is calculated on the basis of production information in the present and subsequent processes and the presence or absence of a delay is determined. In such a manner, a delay or the possibility of a delay is detected, the main cause of the delay is analyzed, and the expedite instruction including a countermeasure to the cause is outputted, thereby enabling a delay to be effectively made up for.

As described above, the production management system of this embodiment can output an accurate expedite instruction to a lot in a production process. A delay of a lot in a production process can be accurately detected. Further, a delivery delay can be made up for on the basis of the states of a lot in a production process and the states of a manufacturing apparatus in a production process and prevented.

Second Embodiment

Hereinafter, description will be given of a production management system according to a second embodiment of the present invention. In the first embodiment, the description has been given of the method of preventing a delay of a lot which it not yet shipped by outputting an expedite instruction to the lot predicted to be late. In the second embodiment, description will be given of a method of effectively executing the method.

The hardware configuration of the production management system of the second embodiment is the same as that of the production management system according to the first embodiment. Therefore, the detailed description will not be repeated.

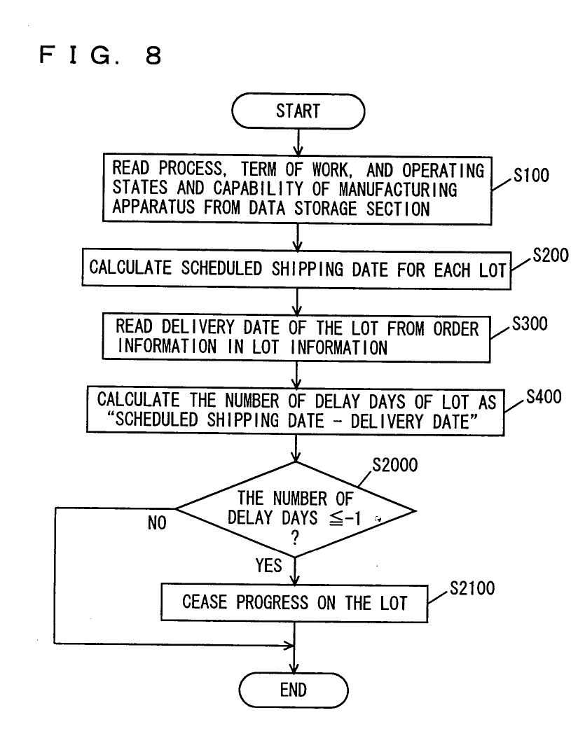

Referring to FIG. 8, description will be given of the control structure of a program executed by processing section 90 of the production management system according to the second embodiment. In the flowchart of FIG. 8, the same step numbers are designated to the same processes as those in the flowchart of FIG. 5. Since the processes are the same, their detailed description will not be repeated herein.

In S2000, processing section 90 determines whether the number of delay days is −1 or not. The number of delay days of −1 expresses a state where the actual delivery date leads the scheduled shipping date by one or more days. That is, it shows a case where the scheduled shipping date has an allowance to the delivery date. When the number of delay days is −1 or less (YES in S2000), the process proceeds to S2100. When not (NO in S2000), the process is finished.

In S2100, processing section 90 ceases progress on the lot.

Description will be given of the operation of the production management system according to the embodiment based on the structure and flowchart. The same operations as those in the production management system of the first embodiment will not be repeated.

The number of delay days of a lot is calculated as “scheduled shipping date—delivery date” (S400). When the number of delay days is −1 or less (YES in S2000), progress on the lot is ceased (S2100). For example, lots LOT01 and LOT03 are to be finished or shipped before the delivery date. Since there is an allowance to the delivery date, progress on a lot having a large allowance (lot LOT03 in FIG. 6) is temporarily ceased.

By performing a process on a lot having a large allowance to the delivery date later, the load on the manufacturing line or a manufacturing apparatus can be lessened. As a result, a state in which a lot predicted to be behind a schedule described in the first embodiment can be expedited more easily can be generated. Decrease in the number of lots which are behind schedules can be expected.

Third Embodiment

Hereinafter, description will be given of a production management system according to a third embodiment of the present invention. The production management system of the third embodiment relates to processes performed in the case where a plurality of lots necessary to be expedited exist.

In the case where a plurality of lots necessary to be expedited such as lot LOT02 in the first embodiment exist, it is not easy to determine the order of giving the expedite instruction to the lots. Hereinafter, description will be given of a case where it is assumed that lots LOT05 and LOT06 necessary to make up for two days and five days, respectively, exist. It is also assumed that the manufacturing line has the capability of making up for two days of one of the lots.

When lot LOT05 is used as an object to be expedited, the delivery delay of lot LOT05 can be made up for, so that the delivery maintenance ratio increases. The delivery maintenance ratio can be effectively increased in such a situation. However, lot LOT06 of which delay is larger is left. Consequently, when lot LOT06 is expedited, the number of delay days is decreased from five to three. Although the delivery maintenance ratio does not improve, there is the possibility that lots having large delays gradually make up for the delays and the delivery maintenance ratio improves in future.

Which one of the options to be selected is determined on the basis of situations of each of the manufacturing lines and sections managing the manufacturing lines. By outputting an expedite instruction by an optimum method using, as parameters, percentage of delivery delay prediction in a line, customer priority, target delivery maintenance ratio, throughput of a manufacturing line, and the like, a delay of the whole production process can be effectively made up for.

Although the production management systems according to the first to third embodiments have been described above, the unit of each of the delivery and shipping schedule is not limited to a day but other time units such as an hour unit or a minute unit may be used.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A production management method for managing a production process of producing products on a lot unit basis, comprising the steps of:
pre-storing production information including a delivery date of said lot, a process amount, a term of work, and operating states and production capabilities of a manufacturing apparatus;
calculating a delivery date prediction for each of said lots on the basis of said production information and determining whether or not there is a delay in each of said lots on the basis of the delivery date prediction and the delivery date;
outputting an alarm for a lot having a delay; and
analyzing the cause of the delay and instructing a proper countermeasure for the cause of the delay when the degree of the delay is higher than a predetermined degree.

2. The production management method according to claim 1, wherein
said production process includes a plurality of processes, and
the method further comprises the step of calculating an updated delivery date prediction for each of said lots on the basis of production information in the present process and subsequent processes and determining the presence or absence of a delay on the basis of the updated delivery date prediction and the delivery date for each of said lots.

3. The production management method according to claim 1, further comprising the step of:
extracting a lot which is not delayed and of which allowance of the delivery date prediction to the delivery date is larger than a predetermined allowance from said lots and temporarily ceasing progress of the extracted lot.

4. The production management method according to claim 2, further comprising the step of:
extracting a lot which is not delayed and of which allowance of the delivery date prediction to the delivery date is larger than a predetermined allowance from said lots and temporarily ceasing progress of the extracted lot.

5. The production management method according to claim 1, further comprising the step of:
determining a lot in two or more lots having a delay, to which a priority is given.

6. The production management method according to claim 2, further comprising the step of:
determining a lot in two or more lots having a delay, to which a priority is given.

7. The production management method according to claim 3, further comprising the step of:
determining a lot in two or more lots having a delay, to which a priority is given.

8. The production management method according to claim 4, further comprising the step of:
determining a lot in two or more lots having a delay, to which a priority is given.
